(19) United States
(12) Patent Application Publication
(10) Pub. No.: US 2024/0222634 A1
(43) Pub. Date: Jul. 4, 2024

(54) NEGATIVE ELECTRODE SLURRY COMPOSITION AND APPLICATION

(71) Applicant: EVE POWER CO., LTD., Jingmen, Hubei (CN)

(72) Inventors: Zhihang ZHOU, Jingmen, Hubei (CN); Qian YANG, Jingmen, Hubei (CN); Fanfen LIU, Jingmen, Hubei (CN); Dingding YUAN, Jingmen, Hubei (CN)

(73) Assignee: EVE POWER CO., LTD., Jingmen, Hubei (CN)

(21) Appl. No.: 18/556,915

(22) PCT Filed: Mar. 15, 2023
(86) PCT No.: PCT/CN2023/081639

§ 371 Date: Oct. 24, 2023

(30) Foreign Application Priority Data
Mar. 15, 2022 (CN) 202210255490.4

(51) Int. Cl. H01M 4/62; H01M 4/04; H01M 4/02

(52) U.S. Cl. CPC H01M 4/622; H01M 4/0404; H01M 2004/027

(57) ABSTRACT

Disclosed are a negative electrode slurry composition and application. The negative electrode slurry composition includes a solvent and negative electrode material components dispersed in the solvent. The negative electrode material components include a negative electrode active substance, a conductive agent, a dispersant, and a binder. The binder includes a binder A and a binder B. The binder A is at least one of polyacrylic acid, polyacrylic salt, polyacrylate, polyacrylonitrile, or polyimide binders. A monomeric unit contained in the binder B is at least one of an aromatic vinyl monomeric unit, an aromatic conjugated diene monomeric unit, an alkenyl unsaturated carboxylic acid monomeric unit, an unsaturated alkyl carboxylate monomeric unit, or an acrylonitrile monomeric unit.

This application claims priority to Chinese Patent Application No. 202210255490.4, filed with China National Intellectual Property Administration on Mar. 15, 2022, which is incorporated herein by reference in its entirety.

### FIELD OF INVENTION

This application belongs to the technical field of negative electrode materials, and more particularly, relates to a negative electrode slurry composition and application.

### BACKGROUND OF INVENTION

In recent years, the new energy industry has been rapidly developed, bringing a significant increase in consumption demand for lithium-ion batteries. The market has higher requirements for energy density, low-temperature performance, fast-charging performance, safety, and manufacturing cost of the lithium-ion batteries.

During normal operation of the lithium-ion battery, lithium ions are intercalated into and deintercalated from active substances of a positive electrode and a negative electrode. When the lithium-ion battery works under some severe working conditions, for example, during low-temperature charging and fast charging, the electrochemical polarization of the negative electrode intensifies, which may cause that the lithium ions are reduced into lithium metal and precipitate out on a surface of the graphite negative electrode, that is, a lithium precipitation phenomenon occurs. After the lithium precipitation occurs on the surface of the negative electrode, the performance of the lithium-ion battery may be seriously affected: (1) a part of the precipitated lithium metal is unable to be oxidized back to lithium ions during discharging, leading to a capacity decay of the battery; and (2) as the electrochemical reaction proceeds, the amount of precipitated lithium gradually increases, finally forming lithium dendrites on surfaces of graphite particles in the negative electrode. In more severe cases, the lithium dendrites may penetrate through a separator, resulting in a short circuit in the battery. At present, most of factories solve the above problems by improving properties of graphite, such as controlling the particle size and interlayer spacing of graphite, liquid-phase surface coating, and surface treatment through high-temperature oxidation and fluoridation.

In the lithium-ion battery, a binder provides adhesive force among the electrode active materials, a conductive agent, and a current collector, which maintains good contact among the active substances, the conductive agent, and the current collector, as well as between the active substances. In the charging and discharging process, the binder can effectively maintain the integrity of an electrode structure, keep good electronic connectivity and stable electrochemical performance, and ensure safe and effective operation of the battery.

In order to solve the problems such as poor low-temperature performance, poor rate capability, and long charging time of the lithium-ion battery, an appropriate binder system can be selected to improve the electrochemical performance of the battery. In a battery system with high energy density and limited charging time, particularly in the process of preparing a negative electrode slurry, sodium carboxymethyl cellulose is usually used as a dispersant, and a styrene-butadiene-based or styrene-acrylate-based polymer is used as the binder to improve the dynamic performance of the battery, such as lithium precipitation and increased internal resistance. In the process of further optimizing the electrode performance, the use of a single binder may lead to that a prepared negative electrode plate becomes brittle and hard, and in the process of machining the negative electrode plate, powder shedding and detachment of active substances of the electrode plate are likely to occur, resulting in a short circuit in the battery system; and on the other hand, the battery experiences rapid decay of capacity and rapid decrease of capacity retention rate during charge-discharge cycles, which does not meet the requirements of practical application scenarios.

Therefore, in response to the above problems, it is expected to develop a negative electrode slurry, a negative electrode plate, and a lithium-ion battery that can improve the low-temperature performance of the battery while maintaining good cycling performance.

### SUMMARY OF INVENTION

The following content is a summary of main topics described in detail in this specification. This summary is not intended to limit the scope of the claims.

In view of the defects in the related art, an objective of this application is to provide a negative electrode slurry composition and application. This application improves the flexibility of a negative electrode plate, enhances the low-temperature discharge and low-temperature lithium precipitation performance of a battery, and meanwhile ensures excellent cycling performance of the battery by the compound use of a dispersant and various types of binder compositions.

In order to achieve the objective of this application, this application adopts the following technical solution:

In a first aspect, an embodiment of this application provides a negative electrode slurry composition. The negative electrode slurry composition includes a solvent and negative electrode material components dispersed in the solvent, and the negative electrode material components include a negative electrode active substance, a conductive agent, a dispersant, and a binder.

In an embodiment, the binder includes a binder A and a binder B.

In an embodiment, the binder A is at least one of polyacrylic acid, polyacrylic salt, polyacrylate, polyacrylonitrile, or polyimide binders.

In an embodiment, a monomeric unit contained in the binder B is at least one of an aromatic vinyl monomeric unit, an aromatic conjugated diene monomeric unit, an alkenyl unsaturated carboxylic acid monomeric unit, an unsaturated alkyl carboxylate monomeric unit, or an acrylonitrile monomeric unit.

The binder B in the embodiments of this application is in a form of emulsion, and bonds the negative electrode active substances, as well as the negative electrode active substance and a current collector in a point-to-point manner. The binder B has good flexibility. The binder A is a solution type of multipolymer, having a molecular structure with abundant functional groups. A network structure is formed in an electrode through a face-to-face manner. On one hand, the formed network structure enhances the adhesive strength between the negative electrode active substances, and between the negative electrode active substances and the current collector. On the other hand, due to the presence of this network structure, channels for intercalation and deintercalation of lithium ions are reserved. However, the binder A is high in brittleness and poor in flexibility, which may cause easy detachment of electrode plate active substances during electrode plate processing, charging, and discharging. Thus, due to the synergistic effect achieved by the binder B and the binder A, a negative electrode plate prepared by the above slurry has higher peel strength and good electrode plate flexibility. Moreover, the single use of the binder A may form unstable carboxylate with an electrolyte and remain in a solid electrolyte interface (SEI) film, forming an unstable SEI film, which worsens the charging and discharging efficiency and cycling performance of an electrochemical apparatus. In the process of preparing the negative electrode slurry composition, the dispersant coats a surface of the negative electrode active substance through adsorption, thereby improving dispersibility of the negative electrode active substance.

In an embodiment, the binder B is selected from any one of acrylic rubber, acrylonitrile-butadiene copolymer, styrene-acrylate copolymer, aromatic vinyl-methacrylate copolymer, styrene-butadiene-acrylic acid terpolymer, and aliphatic conjugated diene-aromatic vinyl-methacrylate terpolymer.

In an embodiment, a glass transition temperature of the binder B is −50° C. to 70° C., for example, may be −50° C., −40° C., −30° C., −20° C., −10° C., −5° C., 0° C., 5° C., 10° C., 20° C., 30° C., 40° C., 50° C., 60° C., or 70° C.

In the embodiments of this application, by adjusting the glass transition temperature of the binder B, the negative electrode plate containing the binder B may be enabled to have good flexibility. If the glass transition temperature is too low, the negative electrode plate may expand excessively in the process of charging and discharging of a cell. If the glass transition temperature is too high, the negative electrode plate may have poor flexibility, which increases the risk of detachment of active substances in the machining process of the negative electrode plate, and leads to a higher rate of short circuit in the cell.

In an embodiment, an average particle size of the binder B is 40 nm-700 nm, for example, may be 40 nm, 50 nm, 60 nm, 80 nm, 100 nm, 200 nm, 300 nm, 400 nm, 500 nm, 600 nm, or 700 nm.

In the embodiments of this application, by adjusting the average particle size of the binder B, the particle-shaped binder B and the electrode active substances in the slurry may have good dispersibility. If the average particle size is too small, agglomeration may occur. If the average particle size is too large, the binder B may have the increased risk of demulsification in the preparing process of the negative electrode slurry, leading to loss in binding performance.

In an embodiment, by taking the total mass of the negative electrode material components as 100%, a mass percentage of the binder B is 0.1%-1.7%, for example, may be 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, or 1.7%.

In the embodiments of this application, by adjusting the mass percentage of the binder B, good adhesion and resistance are provided for the negative electrode active substance, such that the negative electrode plate maintains good flexibility, and the cell has good internal resistance. If the mass percentage is too low, it may result in poor flexibility of the electrode plate and easy detachment of the negative electrode active substance. If the mass percentage is too high, it may result in an increase in the difficulty of slurry processing, as well as an increase in the resistance of the electrode plate and the internal resistance of the cell.

In the embodiments of this application, the addition of the binder A to the negative electrode slurry also has a certain dispersing effect. Therefore, the negative electrode slurry composition system added with the binder A has good dispersibility and slurry stability. It is to be noted that the binding force between the adopted dispersant and the negative electrode active substance is greater than the binding force between the binder A and the active substance. The binder has the functions of assisting in dispersion and providing a binder force. In the subsequent coating and drying processes of electrode manufacturing, the performance of the negative electrode plate can be improved, thereby enhancing dynamic-related performance of an electrochemical energy storage apparatus, such as internal resistance, rate capability, low-temperature performance, and lithium precipitation.

In an embodiment, the binder A is selected from any one or a combination of at least two of polyacrylic acid, polymethacrylic acid, sodium polyacrylate, sodium polymethacrylate, potassium polyacrylate, potassium polymethacrylate, lithium polyacrylate, lithium polymethacrylate, polyacrylamide, or polymethacrylamide, such as polyacrylic acid and polymethacrylic acid, sodium polyacrylate and sodium polymethacrylate, potassium polyacrylate or potassium polymethacrylate. However, the listed types are not exhaustive, and other types of binders not listed in the scope of the binder A may also be adopted.

In an embodiment, by taking the total mass of the negative electrode material components as 100%, a mass percentage of the binder A is 0.5%-2.1%, for example, may be 0.5%, 0.7%, 0.9%, 1.1%, 1.3%, 1.5%, 1.7%, 1.9%, or 2.1%.

In the embodiments of this application, by adjusting the mass percentage of the binder A, the negative electrode plate may have low resistance and good flexibility, such that the cell has low internal resistance. If the mass percentage is too low, it may lead to high resistance of the electrode plate and high internal resistance of the cell. If the mass percentage is too high, it may lead to poor flexibility of the electrode plate and an increase in the risk of detachment of the active substance.

In an embodiment, the dispersant is selected from any one or a combination of at least two of sodium carboxymethyl cellulose, carboxymethyl cellulose, methyl cellulose, ethyl cellulose, hydroxymethyl cellulose, hydroxypropyl cellulose, polyvinyl alcohol, polytetrafluoroethylene, polyvinylidene fluoride, water-based acrylic resin, or ethylene-vinyl acetate copolymer, preferably is sodium carboxymethyl cellulose, and, for example, may be sodium carboxymethyl cellulose and carboxymethyl cellulose, carboxymethyl cellulose, methyl cellulose, ethyl cellulose, or hydroxymethyl cellulose. However, the listed types are not exhaustive, and other types of dispersants not listed in the scope of the dispersant may also be adopted.

In an embodiment, a degree of substitution of hydroxyl in the dispersant is 0.6-1.2, preferably is 0.6-0.75, for example, may be 0.6, 0.65, 0.7, 0.75, 0.8, 0.85, 0.9, 0.95, 1, or 1.2.

In the embodiments of this application, by adjusting the degree of substitution of hydroxyl in the dispersant, the dispersant may have good solubility, the dispersant and the negative electrode active substance are adjusted to have appropriate affinity, and the dispersant evenly exists on the surface of the negative electrode active substance, thereby improving the surface roughness of the negative electrode active material. If the degree of substitution is too low, it may result in poor solubility of the dispersant, which is not conducive to slurry preparation. If the degree of substitution is too high, it may result in a decrease in the affinity between the dispersant and the negative electrode active substance, which hinders the uniform distribution of the dispersant on the surface of the negative electrode active substance.

In the embodiments of this application, dispersants with different degrees of substitution exhibit varying binding forces with the negative electrode active material. The dispersant with low degree of substitution is more favorable for adsorption on the surface of the negative electrode active substance. The dispersants with different degrees of substitution can better wrap the surface of the negative electrode active material, so as to protect the negative electrode active material, and improve the surface roughness of the negative electrode active material, which is beneficial for the formation of the stable SEI film.

In an embodiment, by taking the total mass of the negative electrode material components as 100%, a mass percentage of the dispersant is 0.1%-2.2%, preferably is 0.5%-1.5%, for example, may be 0.1%, 0.3%, 0.5%, 0.7%, 0.9%, 1.1%, 1.3%, 1.5%, 1.8%, 2%, or 2.2%.

In the embodiments of this application, by adjusting the mass percentage of the dispersant, the negative electrode slurry is enabled to have good dispersibility. If the mass percentage is too low, it may result in poor dispersion of the negative electrode slurry and poor stability of the slurry. If the mass percentage is too high, it may result in an increase in resistance of the negative electrode plate and an increase in internal resistance of the cell.

Preferably, the negative electrode active substance includes any one or a combination of at least two of soft carbon, hard carbon, artificial graphite, natural graphite, silicon, a silicon-oxygen compound, a silicon-carbon composite material, or lithium titanate.

In the embodiments of this application, by taking the total mass of the negative electrode material components as 100%, a mass percentage of the negative electrode active substance is 91.8%-98.9%.

In an embodiment, the conductive agent is selected from any one or a combination of at least two of graphite, carbon black, graphene, carbon nanotube conductive fibers, metal powder, conductive whiskers, a conductive metal compound, or conductive polymers.

In an embodiment, by taking the total mass of the negative electrode material components as 100%, a mass percentage of the conductive agent is 0.4%-2.2%, preferably is 0.5%-0.7%, for example, may be 0.4%, 0.45%, 0.5%, 0.55%, 0.6%, 0.65%, 0.7%, 0.8%, 0.9%, 1%, 1.5%, 1.7%, 1.9%, or 2.2%.

In a second aspect, an embodiment of this application provides a method for preparing a negative electrode slurry composition. The preparation method includes:
\textcircled{1} Approach I: Preparation of a negative electrode glue solution: adding a certain amount of dispersant powder to a solvent; mixing in a planetary mixer until the solid is completely dissolved; performing sufficient and uniform stirring for vacuum bubble removal; and storing a prepared glue solution in vacuum for later use. Preparation of a negative electrode slurry: adding graphite and a conductive agent to a stirrer to be evenly mixed to obtain a mixture; adding the above prepared dispersant glue solution to the mixture, and turning on the stirrer to perform primary vacuum disperse operation; after the primary dispersion is completed, adding a small amount of binder A to the turned-on stirrer for secondary stirring and dispersing; after the secondary dispersion is completed, adding an appropriate amount of solvent and the remaining binder A for tertiary stirring and dispersing; and after the above stirring steps are finished, finally adding a binder B to be sufficiently stirred and evenly dispersed.
\textcircled{2} Approach II: adding the graphite, the conductive agent, and the dispersant to the stirrer for dry mixing; adding an appropriate amount of solvent and a part of binder A for the first stirring and dispersion; after the first stirring and dispersion is completed, adding an appropriate amount of solvent and the remaining part of binder A for the second stirring and dispersion; and finally, adding the binder B to be sufficiently stirred and evenly dispersed.
\textcircled{3} Approach III: adding the graphite, the conductive agent, the dispersant, and an appropriate amount of solvent to the stirrer for the first stirring and dispersion; then, adding the binder A and an appropriate amount of solvent for the second stirring and dispersion; and finally, adding the binder B to be sufficiently stirred and evenly dispersed.

As a preferred technical solution of the embodiments of this application, by adopting the preparation method in Approach I, the surface of the negative electrode active material is sufficiently coated with the dispersant, and then the binder A is added in two steps in subsequent steps, which is conducive to sufficient dispersing and mixing of the binder A and the negative electrode active substance.

In a third aspect, an embodiment of this application provides a negative electrode plate. The negative electrode plate includes a current collector and a negative electrode active material layer coating a surface of the current collector. The negative electrode active material layer is prepared by the negative electrode slurry composition according to the first aspect.

In a fourth aspect, an embodiment of this application provides an electrochemical energy storage apparatus. The electrochemical energy storage apparatus includes a housing, a positive electrode plate, a negative electrode plate, an electrolyte, and a separator. The negative electrode plate is the negative electrode plate according to the third aspect.

In this embodiment of this application, the electrochemical energy storage apparatus includes a lithium-ion battery, a sodium-ion battery, or a supercapacitor. The separator is selected from homopolymers, copolymers, as well as mixtures of a polyvinylidene fluoride film, a polyethylene film, a polypropylene film, or the like, which may be selected according to actual situations.

In an embodiment, the positive electrode plate includes a positive electrode active substance and a current collector.

In an embodiment, the positive electrode active substance is selected from any one or a combination of at least two of lithium iron phosphate, lithium manganese iron phosphate, lithium cobalt oxide, lithium nickel oxide, lithium manganese oxide, lithium nickel manganese oxide, lithium nickel cobalt manganese oxide, or lithium nickel cobalt aluminum oxide.

Compared with the related art, this application has the following beneficial effects:

This application provides the negative electrode slurry composition added with the dispersant, the binder A, and the binder B. The dispersant evenly wraps the surface of the negative electrode active substance, which on one hand, assists in dispersing the negative electrode active substance, and on the other hand, helps to form the stable SEI film. In this application, the binder combination is adopted, and the binder A can optimize the electrode structure design, and maintain a good channel for electron and ion transmission. The binder A and the binder B have a synergistic effect, such that the prepared negative electrode plate has good flexibility, which is beneficial for machining, reduces the risk of detachment of the active substance from the electrode plate, and the risk of short circuit of the electrochemical energy storage apparatus, and meanwhile solves the problem that due to using of the single binder A as both the binder and the dispersant, the capacity of the lithium-ion battery rapidly decays in the charging and discharging cycle process.

This application further preferably selects the dispersant with a degree of substitution of hydroxyl of 0.6 to 1.2, which is more conducive to enhancing the dispersibility of the negative electrode slurry and the stability of the slurry.

Other aspects can be understood by reading and comprehending the accompanying drawings and detailed descriptions.

### BRIEF DESCRIPTION OF DRAWINGS

The accompanying drawings are used for providing further understanding of the technical solutions in this specification, form a part of this specification, and are used in conjunction with examples of this application to explain the technical solutions of this specification, but do not limit the technical solutions of this specification.

FIG. 1 is a graph of cycling performance of lithium-ion batteries at 25° C. provided by Application Example 1 and Comparative Application Example 1 to Comparative Application Example 3.

FIG. 2 is a graph of lithium precipitation conditions of lithium-ion batteries at 0° C. provided by Application Example 1 and Comparative Application Example 1 to Comparative Application Example 3.

### DETAILED DESCRIPTION OF PREFERRED EMBODIMENTS

Sources of components in examples are as follows: artificial graphite is purchased from Shinzoom Technology Co., Ltd (serial No.: XC-1); sodium carboxymethyl cellulose is purchased from Nippon Paper (serial No.: MAC 500LC); styrene-butadiene latex is purchased from Zeon (serial No.: 430); and lithium polyacrylate is purchased from Sichuan Indigo, (serial No.: LA 133).

### Example 1

This example provides a negative electrode slurry composition. The negative electrode slurry composition comprises deionized water and negative electrode material components dispersed in the deionized water. The negative electrode material components include graphite, conductive carbon black, a dispersant, and a binder. The binder includes lithium polyacrylate and styrene-butadiene latex. The styrene-butadiene latex has a glass transition temperature of 0° C., and an average particle size of 100 nm.

A method for preparing the negative electrode slurry composition is as below:

A certain amount of powder of the sodium carboxymethyl cellulose dispersant was added to the deionized water to be stirred and mixed evenly to prepare a glue solution with a solid content of 1.5%, where the degree of substitution of hydroxyl in the sodium carboxymethyl cellulose dispersant was 0.71. The graphite and the conductive carbon black were added to a stirrer for uniform mixing. After mixing, a certain amount of the above glue solution was added for blending, and then 30% of the lithium polyacrylate binder was added for secondary stirring and dispersion. After the secondary dispersion was completed, an appropriate amount of the deionized water and the remaining 70% of the lithium polyacrylate binder were added for stirring and dispersion. Finally, the styrene-butadiene latex was added for uniform stirring. A mass ratio of graphite:conductive carbon black:sodium carboxymethyl cellulose:lithium polyacrylate:styrene-butadiene latex in the negative electrode material components of the entire negative electrode slurry composition was 96.7:0.6:0.5:1.8:0.4, thereby obtaining the negative electrode slurry composition.

A method for preparing the negative electrode plate is as below:

The prepared slurry was coated on a current collector, where a thickness of the current collector copper foil was 8 μm, and then oven drying, rolling, and cutting were performed to form the negative electrode plate used in preparing a battery.

### Example 2

This example provides a negative electrode slurry composition. The negative electrode slurry composition comprises deionized water and negative electrode material components dispersed in the deionized water. The negative electrode material components include graphite, conductive carbon black, a dispersant, and a binder. The binder includes lithium polyacrylate and styrene-butadiene latex. The styrene-butadiene latex has a glass transition temperature of 30° C., and an average particle size of 200 nm.

A method for preparing the negative electrode slurry composition is as below:

A certain amount of powder of the sodium carboxymethyl cellulose dispersant was added to the deionized water to be stirred and mixed evenly to prepare a glue solution with a solid content of 1.5%, where the degree of substitution of hydroxyl in the sodium carboxymethyl cellulose dispersant was 0.85. The graphite and the conductive carbon black were added to a stirrer for uniform mixing. After mixing, a certain amount of the above glue solution was added for blending, and then 30% of the lithium polyacrylate binder was added for secondary stirring and dispersion. After the secondary dispersion was completed, an appropriate amount of the deionized water and the remaining 70% of the lithium polyacrylate binder were added for stirring and dispersion. Finally, the styrene-butadiene latex was added for uniform stirring. A mass ratio of graphite:conductive carbon black:sodium carboxymethyl cellulose:lithium polyacrylate:styrene-butadiene latex in the negative electrode material components of the entire negative electrode slurry composition was 96.3:0.5:1:1.3:0.9, thereby obtaining the negative electrode slurry composition.

A method for preparing the negative electrode plate is as below:

The method for preparing the negative electrode plate in this example is the same as that described in Example 1.

### Example 3

This example provides a negative electrode slurry composition. The negative electrode slurry composition comprises deionized water and negative electrode material components dispersed in the deionized water. The negative electrode material components include graphite, conductive carbon black, a dispersant, and a binder. The binder includes lithium polyacrylate and styrene-butadiene latex. The styrene-butadiene latex has a glass transition temperature of 40° C., and an average particle size of 540 nm.

A method for preparing the negative electrode slurry composition is as below:

A certain amount of powder of the sodium carboxymethyl cellulose dispersant was added to the deionized water to be stirred and mixed evenly to prepare a glue solution with a solid content of 1.5%, where the degree of substitution of hydroxyl in the sodium carboxymethyl cellulose dispersant was 0.75. The graphite and the conductive carbon black were added to a stirrer for uniform mixing. After mixing, a certain amount of the above glue solution was added for blending, and then 30% of the lithium polyacrylate binder was added for secondary stirring and dispersion. After the secondary dispersion was completed, an appropriate amount of the deionized water and the remaining 70% of the lithium polyacrylate binder were added for stirring and dispersion. Finally, the styrene-butadiene latex was added for uniform stirring. A mass ratio of graphite:conductive carbon black:sodium carboxymethyl cellulose:lithium polyacrylate:styrene-butadiene latex in the negative electrode material components of the entire negative electrode slurry composition was 95.6:0.7:1.5:0.9:1.3, thereby obtaining the negative electrode slurry composition.

A method for preparing the negative electrode plate is as below:

The method for preparing the negative electrode plate in this example is the same as that described in Example 1.

### Example 4

This example provides a negative electrode slurry composition. The negative electrode slurry composition comprises deionized water and negative electrode material components dispersed in the deionized water. The negative electrode material components include graphite, conductive carbon black, a dispersant, and a binder. The binder includes lithium polyacrylate and styrene-butadiene latex. The styrene-butadiene latex has a glass transition temperature of −50° C., and an average particle size of 40 nm.

A method for preparing the negative electrode slurry composition is as below:

A certain amount of powder of the sodium carboxymethyl cellulose dispersant was added to the deionized water to be stirred and mixed evenly to prepare a glue solution with a solid content of 1.5%, where the degree of substitution of hydroxyl in the sodium carboxymethyl cellulose dispersant was 0.6. The graphite and the conductive carbon black were added to a stirrer for uniform mixing. After mixing, a certain amount of the above glue solution was added for blending, and then 30% of the lithium polyacrylate binder was added for secondary stirring and dispersion. After the secondary dispersion was completed, an appropriate amount of the deionized water and the remaining 70% of the lithium polyacrylate binder were added for stirring and dispersion. Finally, the styrene-butadiene latex was added for uniform stirring. A mass ratio of graphite:conductive carbon black:sodium carboxymethyl cellulose:lithium polyacrylate:styrene-butadiene latex in the negative electrode material components of the entire negative electrode slurry composition was 98.9:0.4:0.1:0.5:0.1, thereby obtaining the negative electrode slurry composition.

A method for preparing the negative electrode plate is as below:

The method for preparing the negative electrode plate in this example is the same as that described in Example 1.

### Example 5

This example provides a negative electrode slurry composition. The negative electrode slurry composition comprises deionized water and negative electrode material components dispersed in the deionized water. The negative electrode material components include graphite, conductive carbon black, a dispersant, and a binder. The binder includes lithium polyacrylate and styrene-butadiene latex. The styrene-butadiene latex has a glass transition temperature of 70° C., and an average particle size of 700 nm.

A method for preparing the negative electrode slurry composition is as below:

A certain amount of powder of the sodium carboxymethyl cellulose dispersant was added to the deionized water to be stirred and mixed evenly to prepare a glue solution with a solid content of 1.5%, where the degree of substitution of hydroxyl of the sodium carboxymethyl cellulose dispersant was 1.2. The graphite and the conductive carbon black were added to a stirrer for uniform mixing. After mixing, a certain amount of the above glue solution was added for blending, and then 30% of the lithium polyacrylate binder was added for secondary stirring and dispersion. After the secondary dispersion was completed, an appropriate amount of the deionized water and the remaining 70% of the lithium polyacrylate binder were added for stirring and dispersion. Finally, the styrene-butadiene latex was added for uniform stirring. A mass ratio of graphite:conductive carbon black:sodium carboxymethyl cellulose:lithium polyacrylate:styrene-butadiene latex in the negative electrode material components of the entire negative electrode slurry composition was 91.8:2.2:2.2:2.1:1.7, thereby obtaining the negative electrode slurry composition.

A method for preparing the negative electrode plate is as below:

The method for preparing the negative electrode plate in this example is the same as that described in Example 1.

### Example 6

The difference between this example and Example 1 is that the glass transition temperature of the styrene-butadiene latex is −55° C., and other aspects remain the same as those in Example 1.

### Example 7

The difference between this example and Example 1 is that the glass transition temperature of the styrene-butadiene latex is 75° C., and other aspects remain the same as those in Example 1.

### Example 8

The difference between this example and Example 1 is that the mass ratio of graphite:conductive carbon black:sodium carboxymethyl cellulose:lithium polyacrylate:styrene-butadiene latex in the negative electrode material components of the entire negative electrode slurry composition is 97.08:0.6:0.5:1.8:0.02, and other aspects remain the same as those in Example 1.

### Example 9

The difference between this example and Example 1 is that the mass ratio of graphite:conductive carbon black:sodium carboxymethyl cellulose:lithium polyacrylate:styrene-butadiene latex in the negative electrode material components of the entire negative electrode slurry composition is 94.1:0.6:0.5:1.8:3, and other aspects remain the same as those in Example 1.

### Example 10

The difference between this example and Example 1 is that the mass ratio of graphite:conductive carbon black:sodium carboxymethyl cellulose:lithium polyacrylate:styrene-butadiene latex in the negative electrode material components of the entire negative electrode slurry composition is 98.4:0.6:0.5:0.1:0.4, and other aspects remain the same as those in Example 1.

### Example 11

The difference between this example and Example 1 is that the mass ratio of graphite:conductive carbon black:sodium carboxymethyl cellulose:lithium polyacrylate:styrene-butadiene latex in the negative electrode material components of the entire negative electrode slurry composition is 95.5:0.6:0.5:3:0.4, and other aspects remain the same as those in Example 1.

### Example 12

The difference between this example and Example 1 is that the degree of substitution of hydroxyl in the sodium carboxymethyl cellulose dispersant is 0.1, and other aspects remain the same as those in Example 1.

### Example 13

The difference between this example and Example 1 is that the degree of substitution of hydroxyl in the sodium carboxymethyl cellulose dispersant is 1.7, and other aspects remain the same as those in Example 1.

### Comparative Example 1

This comparative example 1 provides a negative electrode slurry composition. A preparation method of the same is as below:

A certain amount of powder of the sodium carboxymethyl cellulose dispersant was added to the deionized water to be stirred and mixed evenly to prepare a glue solution with a solid content of 1.5%, where the degree of substitution of hydroxyl in the sodium carboxymethyl cellulose dispersant was 0.71. Graphite and conductive carbon black were added to a stirrer for uniform mixing. After mixing, 64% of a mass of the above glue solution was added for blending. After blending was completed, an appropriate amount of the deionized water and the remaining 36% of the mass of the sodium carboxymethyl cellulose solution were added for stirring and dispersion. Finally, styrene-butadiene latex was added for uniform stirring. The mass ratio of graphite:conductive carbon black:sodium carboxymethyl cellulose:styrene-butadiene latex in the negative electrode material components of the entire negative electrode slurry composition was 96.7:0.6:1.2:1.5, thereby obtaining the negative electrode slurry composition.

The method for preparing the negative electrode plate is the same as that described in Example 1.

### Comparative Example 2

This comparative example provides a negative electrode slurry composition. A preparation method of the same is as below:

Graphite and conductive carbon black were added to a stirrer for uniform mixing. After mixing, a certain amount of the above glue solution was added for blending, and then 40% of the lithium polyacrylate was added for secondary stirring and dispersion. After the dispersion was completed, an appropriate amount of deionized water and the remaining 60% of the lithium polyacrylate were added for stirring and dispersion, and stirring was sufficient and uniform. The mass ratio of graphite:conductive carbon black:lithium polyacrylate in the negative electrode material components of the entire negative electrode slurry composition was 97.6:0.6:1.8, thereby obtaining the negative electrode slurry composition.

The method for preparing the negative electrode plate is the same as that described in Example 1.

### Comparative Example 3

The difference between this example and Example 1 is that no lithium polyacrylate is added in the process of preparing the negative electrode slurry composition, and the mass ratio of graphite:conductive carbon black:sodium carboxymethyl cellulose:styrene-butadiene latex in the negative electrode material components of the entire negative electrode slurry composition is 96.7:0.6:0.5:2.2, and other aspects remain the same as those in Example 1.

### Comparative Example 4

The difference between this example and Example 1 is that no styrene-butadiene latex is added in the process of preparing the negative electrode slurry composition, and the mass ratio of graphite:conductive carbon black:sodium carboxymethyl cellulose:lithium polyacrylate in the negative electrode material components of the entire negative electrode slurry composition is 96.7:0.6:0.5:2.2, and other aspects remain the same as those in Example 1.

### Comparative Example 5

The difference between this example and Example 1 is that in the process of preparing the negative electrode slurry composition, the styrene-butadiene latex is replaced with a conventional styrene-butadiene latex, namely, a butadiene-styrene copolymer, and the conventional styrene-butadiene latex has a glass transition temperature of 85° C., and an average particle size of 800 nm. Other aspects remain the same as those in Example 1.

### Comparative Example 6

The difference between this example and Example 1 is that in the process of preparing the negative electrode slurry composition, lithium polyacrylate is replaced with sodium alginate, and other aspects remain the same as those in Example 1.

### Application Example 1 to Application Example 13, and Comparative Application Example 1 to Comparative Application Example 6

Lithium-ion batteries are prepared by the negative electrode slurry compositions provided by Example 1 to Example 13, and Comparative Example 1 to Comparative Example 6 and using the following preparation method:

Preparation of positive electrode slurry and positive electrode plate: a certain amount of powder of a polyvinylidene fluoride binder was added to an N-methylpyrrolidone solvent to be evenly stirred and mixed to prepare a glue solution with a solid content of 8%. Positive electrode active substances including lithium iron phosphate, a carbon nanotube, conductive carbon black, and polyvinylidene fluoride in a mass ratio of 97.5:0.4:0.5:1.6 were added to a stirrer. After sufficient and uniform stirring, a positive electrode slurry was obtained. The prepared slurry is coated on a current collector, and the thickness of the current collector carbon-coated aluminum foil was 16 μm. Then oven drying, rolling, and cutting were performed to prepare a positive electrode plate used for a battery.

Separator: a polyethylene porous polymer film was adopted as the separator.

Preparation of electrolyte solution: the electrolyte solution included a lithium salt, an organic solvent, and an additive. The lithium salt was LiPF₆ with a concentration of 1.00 mol/L, and the organic solvent was a mixture of ethylene carbonate (EC), propylene carbonate (PC), ethyl methyl carbonate (EMC), and fluoro-benzene (FB) in a ratio of 30:10:58:4.

Preparation of lithium-ion battery: the positive electrode plate, the negative electrode plate, the separator, and the electrolyte solution were assembled. The separator was placed between the positive electrode plate and the negative electrode plate, and wound or stacked to obtain a bare cell. The bare cell was placed in an outer package aluminum-plastic film or an aluminum shell to be assembled into a cell. The electrolyte solution was injected into the dried cell, and technological processes of stacking, welding, adhesive application, assembly, electrolyte injection, formation, shaping, capacity grading, and testing were conducted to form a finished pouch lithium-ion battery.

### Test Conditions

The lithium-ion batteries prepared in Application Example 1 to Application Example 13 and Comparative Application Example 1 to Comparative Application Example 6 are respectively subjected to tests for ambient-temperature cycling, high-temperature storage performance, and high-temperature cycling performance. The testing method is as follows:
(1) Ambient-temperature cycling: the above prepared pouch batteries were placed in a constant temperature chamber at 25° C., charged at a constant current of 1 C and constant voltage to 3.65 V, and then discharged at a constant current to 2.5 V, which were repeated 3000 times.

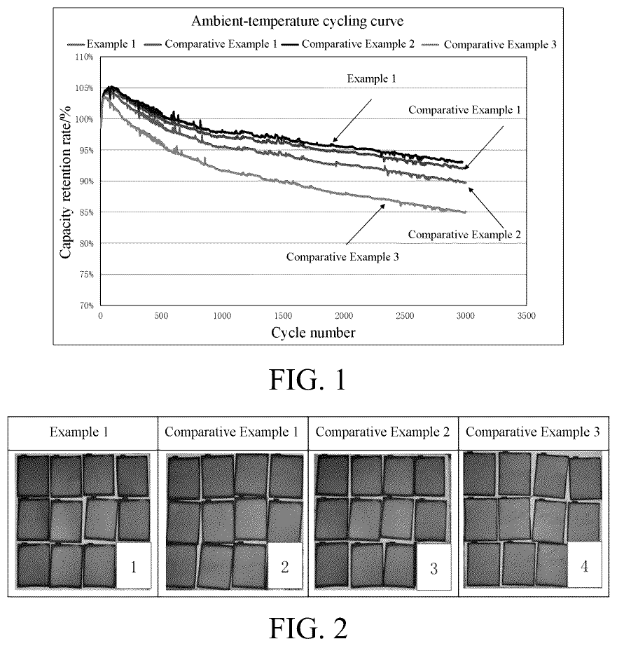

FIG. 1 is a graph of cycling performance of lithium-ion batteries at 25° C. provided by Application Example 1 and Comparative Application Example 1 to Comparative Application Example 3. As shown in FIG. 1, the battery provided in Application Example 1 of this application exhibits higher cycling stability compared to the batteries provided in Comparative Example 1 to Comparative Example 3.
(2) Storage performance: the above prepared pouch batteries were placed in a constant temperature chamber at 25° C. for 2 h, charged at a constant current of 0.5 C and constant voltage to 3.65 V with standing for 5 min, and then discharged at a constant current of 0.5 C to 2.50 V, where the discharge capacity of the cells was C₁; the batteries were stored at 55° C. for 30 d, then placed in the constant temperature chamber at 25° C. for 2 h, and discharged at a constant current of 0.5 C to 2.50 V, where the discharge capacity was C₂; the batteries were charged at a constant current of 0.5 C and constant voltage to 3.65 V at 25±2° C., with standing for 5 min, and then discharged at a constant current of 0.5 C to 2.50 V, the process was repeated for 5 cycles, and the discharged average capacity was C₃. A capacity retention rate may be expressed as a ratio of the discharge capacity C₂ to the discharge capacity C₁; and a capacity recovery rate may be expressed as a ratio of the discharge capacity C₃ to the discharge capacity C₁.
(3) Lithium precipitation test at 0° C.: the batteries were put aside at 0±2° C. for 2 h, at a set current of 0.2 C (A), charged at a constant current of 0.2 C and constant voltage to 3.65 V with standing for 5 min, and then discharged at a constant current of 0.2 C to 2.00 V, and the process was repeated for 3 cycles, followed by a full charge and disassembly.

FIG. 2 is a graph of lithium precipitation conditions of lithium-ion batteries at 0° C. provided by Application Example 1 and Comparative Application Example 1 to Comparative Application Example 3. As shown in FIG. 2, lithium precipitation does not occur in Application Example 1.

Test results are shown in Table 1:

TABLE 1

| | Capacity | | | |
|---|---|---|---|---|
| | retention | Storage Performance | | |
| | rate after | Capacity | Capacity | Lithium |
| | 3000 cycles | retention | recovery | precipitation |
| | at 25° C. (%) | rate (%) | rate (%) | at an interface |
| Example 1 | 89.72 | 93.77 | 95.19 | No lithium |
| | | | | precipitation |
| Example 2 | 89.55 | 92.72 | 95.57 | No lithium |
| | | | | precipitation |
| Example 3 | 89.68 | 92.70 | 95.30 | No lithium |
| | | | | precipitation |
| Example 4 | 88.12 | 93.12 | 95.78 | No lithium |
| | | | | precipitation |
| Example 5 | 87.99 | 93.06 | 95.36 | No lithium |
| | | | | precipitation |
| Example 6 | 80.34 | 90.66 | 92.69 | Lithium |
| | | | | precipitation |
| Example 7 | 80.55 | 90.32 | 92.78 | Lithium |
| | | | | precipitation |
| Example 8 | 81.54 | 91.35 | 93.68 | Lithium |
| | | | | precipitation |
| Example 9 | 81.22 | 91.41 | 93.82 | Lithium |
| | | | | precipitation |
| Example 10 | 80.12 | 91.56 | 91.18 | Lithium |
| | | | | precipitation |
| Example 11 | 78.14 | 89.39 | 90.88 | Lithium |
| | | | | precipitation |
| Example 12 | 79.57 | 91.40 | 93.79 | Lithium |
| | | | | precipitation |
| Example 13 | 81.22 | 91.85 | 93.81 | Lithium |
| | | | | precipitation |
| Comparative | 93.00 | 93.84 | 95.75 | Lithium |
| Example 1 | | | | precipitation |
| Comparative | 84.91 | 90.42 | 91.78 | No lithium |
| Example 2 | | | | precipitation |
| Comparative | 93.12 | 91.11 | 91.98 | Lithium |
| Example 3 | | | | precipitation |
| Comparative | 88.35 | 88.78 | 89.98 | No lithium |
| Example 4 | | | | precipitation |
| Comparative | 80.54 | 91.55 | 92.11 | Lithium |
| Example 5 | | | | precipitation |
| Comparative | 87.66 | 92.88 | 94.33 | Lithium |
| Example 6 | | | | precipitation |

Based on the data in Table 1, compared with Example 1, Comparative Example 1 indicates that due to the addition of the binder B, the flexibility of the electrode plates is good; and in the charging and discharging process, the active substances in the electrodes are unlikely to detach, which has a smaller impact on capacity decay during battery cycling, and the capacity retention rate is relatively good. However, in Comparative Example 1, no binder A is added for improving the resistance of the electrode plates, and consequently, lithium precipitation occurs at the electrode plate interface in the lithium precipitation test at 0° C.

Compared with Example 1, Comparative Example 2 indicates that the single use of the binder A may form unstable carboxylate with the electrolyte and remain inside of an SEI film, forming an unstable SEI film, which worsens the cycling performance and storage performance of the electrochemical apparatus. A molecular structure of the binder A has abundant functional groups, which form a network structure in the electrode through a face-to-face manner. Due to the presence of this network structure, channels for intercalation and deintercalation of lithium ions are reserved, low-temperature lithium precipitation performance is improved, and thus, lithium precipitation does not occur at the interface in the lithium precipitation test at 0° C. The sodium carboxymethyl cellulose dispersant preferably binds with the negative electrode active substance, which can better wrap around the active surface of the negative electrode, protect the negative electrode active material, improve the surface roughness of a carbon-based active material, and help to form a stable SEI film, thereby achieving good cycling performance and storage performance.

Comparative analysis of the data from Comparative Example 3 and Comparative Example 4 with Example 1 reveals a synergistic effect between the binder A and the binder B. In Comparative Example 3, the lithium polyacrylate binder A was not added, and an excessive amount of binder B was added. The high resistance of the negative electrode plate and an increase in the internal resistance of the cell caused severe lithium precipitation at the interface. In Comparative Example 4, the styrene-butadiene latex binder B was not added, and an excessive amount of binder A was added, resulting in poor flexibility of the electrode plates, easy detachment of the active substances from the current collector, a low capacity retention rate after cycling, and low capacity retention rate and recovery rate after storage.

Comparative analysis of the data from Comparative Example 5 and Comparative Example 6 with Example 1 reveals that in Comparative Example 5, the binder B was replaced with the conventional styrene-butadiene latex, as a result, the flexibility of the electrode plates was not effectively improved, the internal resistance of the electrode plates and the cell was high, the capacity retention rate of the battery after cycling was low, the capacity retention rate and the recovery rate after storage were low, and lithium precipitation occurred at the interface. In Comparative Example 6, the lithium polyacrylate binder A was replaced with the sodium alginate, as a result, the internal resistance of the electrode plates and the cell was not improved, and lithium precipitation occurred at the interface.

1. A negative electrode slurry composition, comprising: a solvent and negative electrode material components dispersed in the solvent, wherein the negative electrode material components comprise a negative electrode active substance, a conductive agent, a dispersant, and a binder;
the binder comprises a binder A and a binder B;
the binder A is at least one of polyacrylic acid, polyacrylic salt, polyacrylate, polyacrylonitrile, or polyimide binders; and
a monomeric unit contained in the binder B is at least one of an aromatic vinyl monomeric unit, an aromatic conjugated diene monomeric unit, an alkenyl unsaturated carboxylic acid monomeric unit, an unsaturated alkyl carboxylate monomeric unit, or an acrylonitrile monomeric unit.

2. The negative electrode slurry composition according to claim 1, wherein the binder B is selected from any one of acrylic rubber, acrylonitrile-butadiene copolymer, styrene-acrylate copolymer, aromatic vinyl-methacrylate copolymer, styrene-butadiene-acrylic acid terpolymer, or aliphatic conjugated diene-aromatic vinyl-methacrylate terpolymer.

3. The negative electrode slurry composition according to claim 1, wherein a glass transition temperature of the binder B is −50° C. to 70° C.

4. The negative electrode slurry composition according to claim 1, wherein an average particle size of the binder B is 40 nm-700 nm.

5. The negative electrode slurry composition according to claim 1, wherein by taking a total mass of the negative electrode material components as 100%, a mass percentage of the binder B is 0.1%-1.7%.

6. The negative electrode slurry composition according to claim 1, wherein the binder A is selected from any one or a combination of at least two of polyacrylic acid, polymethacrylic acid, sodium polyacrylate, sodium polymethacrylate, potassium polyacrylate, potassium polymethacrylate, lithium polyacrylate, lithium polymethacrylate, polyacrylamide, or polymethacrylamide.

7. The negative electrode slurry composition according to claim 1, wherein by taking a total mass of the negative electrode material components as 100%, a mass percentage of the binder A is 0.5%-2.1%.

8. The negative electrode slurry composition according to claim 1, wherein the dispersant is selected from any one or a combination of at least two of sodium carboxymethyl cellulose, carboxymethyl cellulose, methyl cellulose, ethyl cellulose, hydroxymethyl cellulose, hydroxypropyl cellulose, polyvinyl alcohol, polytetrafluoroethylene, polyvinylidene fluoride, water-based acrylic resin, or ethylene-vinyl acetate copolymer, and preferably sodium carboxymethyl cellulose.

9. The negative electrode slurry composition according to claim 1, wherein a degree of substitution of hydroxyl in the dispersant is 0.6-1.2, and preferably 0.6-0.75.

10. The negative electrode slurry composition according to claim 1, wherein by taking a total mass of the negative electrode material components as 100%, a mass percentage of the dispersant is 0.1%-2.2%, and preferably 0.5%-1.5%.

11. The negative electrode slurry composition according to claim 1, wherein the negative electrode active substance comprises any one or a combination of at least two of soft carbon, hard carbon, artificial graphite, natural graphite, silicon, a silicon-oxygen compound, a silicon-carbon composite material, or lithium titanate.

12. The negative electrode slurry composition according to claim 1, wherein the conductive agent is selected from any one or a combination of at least two of graphite, carbon black, graphene, carbon nanotube conductive fibers, metal powder, conductive whiskers, a conductive metal compound, or conductive polymers.

13. The negative electrode slurry composition according to claim 1, wherein by taking a total mass of the negative electrode material components as 100%, a mass percentage of the conductive agent is 0.4%-2.2%, and preferably 0.5%-0.7%.

14. A negative electrode plate, comprising a current collector and a negative electrode active material layer coating a surface of the current collector, wherein the negative electrode active material layer is prepared by a negative electrode slurry composition, and the negative electrode slurry composition comprises: a solvent and negative electrode material components dispersed in the solvent, wherein the negative electrode material components comprise a negative electrode active substance, a conductive agent, a dispersant, and a binder;
the binder comprises a binder A and a binder B;
the binder A is at least one of polyacrylic acid, polyacrylic salt, polyacrylate, polyacrylonitrile, or polyimide binders; and
a monomeric unit contained in the binder B is at least one of an aromatic vinyl monomeric unit, an aromatic conjugated diene monomeric unit, an alkenyl unsaturated carboxylic acid monomeric unit, an unsaturated alkyl carboxylate monomeric unit, or an acrylonitrile monomeric unit.

15. An electrochemical energy storage apparatus, comprising a housing, a positive electrode plate, a negative electrode plate, an electrolyte, and a separator, wherein the negative electrode plate comprises a first current collector and a negative electrode active material layer coating a surface of the first current collector, the negative electrode active material layer is prepared by a negative electrode slurry composition, and the negative electrode slurry composition comprises: a solvent and negative electrode material components dispersed in the solvent, wherein the negative electrode material components comprise a negative electrode active substance, a conductive agent, a dispersant, and a binder;
the binder comprises a binder A and a binder B;
the binder A is at least one of polyacrylic acid, polyacrylic salt, polyacrylate, polyacrylonitrile, or polyimide binders; and
a monomeric unit contained in the binder B is at least one of an aromatic vinyl monomeric unit, an aromatic conjugated diene monomeric unit, an alkenyl unsaturated carboxylic acid monomeric unit, an unsaturated alkyl carboxylate monomeric unit, or an acrylonitrile monomeric unit.

16. The electrochemical energy storage apparatus according to claim 15, wherein the positive electrode plate comprises a positive electrode active substance and a second current collector.

17. The electrochemical energy storage apparatus according to claim 16, wherein the positive electrode active substance is selected from any one or a combination of at least two of lithium iron phosphate, lithium manganese iron phosphate, lithium cobalt oxide, lithium nickel oxide, lithium manganese oxide, lithium nickel manganese oxide, lithium nickel cobalt manganese oxide, or lithium nickel cobalt aluminum oxide.

18. The negative electrode slurry composition according to claim 1, wherein a glass transition temperature of the binder B is −50° C. to 70° C.; by taking a total mass of the negative electrode material components as 100%, a mass percentage of the binder A is 0.5%-2.1%, and a mass percentage of the binder B is 0.1%-1.7%; and a degree of substitution of hydroxyl in the dispersant is 0.6-1.2.

19. The negative electrode plate according to claim 14, wherein a glass transition temperature of the binder B is −50° C. to 70° C.; by taking a total mass of the negative electrode material components as 100%, a mass percentage of the binder A is 0.5%-2.1%, and a mass percentage of the binder B is 0.1%-1.7%; and a degree of substitution of hydroxyl in the dispersant is 0.6-1.2.

20. The electrochemical energy storage apparatus according to claim 15, wherein in the negative electrode plate, a glass transition temperature of the binder B is −50° C. to 70° C.; by taking a total mass of the negative electrode material components as 100%, a mass percentage of the binder A is 0.5%-2.1%, and a mass percentage of the binder B is 0.1%-1.7%; and a degree of substitution of hydroxyl in the dispersant is 0.6-1.2.
